(19) United States
(12) Patent Application Publication
(10) Pub. No.: US 2025/0059713 A1
(43) Pub. Date: Feb. 20, 2025

(54) COATED PAPERBOARD

(71) Applicant: Billerud Aktiebolag (publ), Solna (SE)

(72) Inventors: Wouter Prosper, Kopparberg (SE); Johan A. Larsson, Gävle (SE)

(21) Appl. No.: 18/723,408

(22) PCT Filed: Dec. 22, 2022
(86) PCT No.: PCT/EP2022/087554

§ 371 Date: Jun. 21, 2024

(30) Foreign Application Priority Data
Dec. 22, 2021 (EP) 21216855.3

(51) Int. Cl. D21J 1/08; B32B 27/10; B32B 27/32; C08K 3/34; C09D 5/16; C09D 7/61; C09D 123/00

(52) U.S. Cl. CPC D21J 1/08; B32B 27/10; B32B 27/32; C09D 5/1668; C09D 7/61; C09D 123/00; B32B 2250/02; B32B 2255/12; B32B 2255/26; B32B 2255/28; B32B 2307/4026; B32B 2307/718; C08K 2003/343

(57) ABSTRACT

There is provided a coated paperboard product comprising:—a paperboard substrate: and—a barrier coating, wherein the barrier coating comprises talc and a polyolefin-based binder and wherein the amount of tale in the barrier coating is 15-40 wt-% based on the dry weight of the barrier coating; and—a pre-coating arranged between the paperboard substrate and the barrier coating.

### TECHNICAL FIELD

The present disclosure relates to the field of coated paperboard and in particular to coated paperboard for use in packaging of fatty & liquid food.

### BACKGROUND

Conventional coated paperboard for use in liquid food packaging comprises two outer layers of extrusion-coated polyethylene (PE) on the central paperboard. The PE-coatings serves to protect the paperboard from liquid inside the package as well as liquid and moisture from the outside as the structural integrity of the paperboard otherwise would deteriorate and ultimately be lost.

Moreover, the PE-coatings are heat-sealable making it possible to produce a package from a PE-coated board by heat-sealing it to itself.

From an environmental perspective it is desirable to reduce the amount of PE used in coated paperboards for use in packaging, especially in liquid food packaging.

In EP 2 199 077 A1 an oxygen barrier is formed by liquid film coating of a dispersible or dissolvable polymer, preferably PVOH, EVOH or starch is disclosed. The polymer binder of the dispersion or solution to be coated as a liquid film is mixed with inorganic compounds such as laminar talcum particles in amount of 30-50 wt %.

In GB 2 473 718 A a board is coated with a mixture of talcum powder, resin, preferably epoxy resin, calcium carbonate and polyolefin to create a water-proofing layer.

### SUMMARY

The present disclosure aims to provide a paperboard product for use in packaging, especially in liquid packaging, where water-vapour barrier and water-resistance properties as well as heat-sealability are important.

Moreover, a reduction of the amount of polyethylene (PE) regularly applied to paperboard products used in liquid packaging should be possible to reduce.

There is, thus, provided the following listing of itemized embodiments:
1. A coated paperboard product comprising:
   a paperboard substrate; and
   a barrier coating, wherein the barrier coating comprises talc and a polyolefin-based binder and wherein the amount of talc in the barrier coating is 15-40 wt-% based on the dry weight of the barrier coating; and
   a pre-coating arranged between the paperboard substrate and the barrier coating.
2. The coated paperboard product of item 1, wherein the paperboard substrate comprises a first layer and a second layer.
3. The coated paperboard of item 2, wherein the first and second layer of the paperboard substrate comprises chemical pulp, such as kraft pulp.
4. The coated paperboard of item 3, wherein the first and second layers of the paperboard substrate each comprises at least 80 wt-% kraft pulp based on the dry weight of the first and second layers.
5. The coated paperboard of any one of items 2-4, wherein the density measured according to ISO 534:2011 of the first and second layers of the paperboard substrate is above 650 kg/m³, such as above 700 kg/m³.
6. The coated paperboard of any one of items 2-5, wherein the paperboard substrate further comprises a third layer arranged between the first layer and the second layer, wherein the third layer comprises mechanical pulp, such as chemitermomechanical pulp (CTMP).
7. The coated paperboard of item 6, wherein the density measured according to ISO 534:2011 of the third layer of the paperboard substrate is below 600 kg/m³, such as below 550 kg/m³.
8. The coated paperboard product of any of the preceding items, wherein the grammage measured according to ISO 536:2020 of the paperboard substrate is 120-300 g/m², such as 125-280 g/m².
9. The coated paperboard product of any of the preceding items, wherein the coat weight of the barrier coating is at least 4 g/m², such as 4-15 g/m², such as 5-10 g/m².
10. The coated paperboard product of any of the preceding items, wherein the polyolefin-based binder is a polyethylene (PE)-based binder.
11. The coated paperboard product of item 10, wherein the PE-based binder comprises ethylene-co-alkene copolymers.
12. The coated paperboard product of item 10 or 11, wherein the PE-based binder comprises a copolymer of ethylene and a carboxylic acid monomer.
13. The coated paperboard product of any of the preceding items, wherein the paperboard substrate has a first side forming a top side and a second side forming a reverse side and wherein the paperboard product comprises said barrier coating on the top side of the paperboard substrate.
14. The coated paperboard product of any one of items 11-13, wherein the paperboard product comprises said barrier coating on the topside and on the reverse side of the paperboard substrate.
15. The coated paperboard product of any one of items 11-14, further comprising a PE-layer being the outer layer on the reverse side of the paperboard substrate.
16. The coated paperboard product of any one of the preceding items, wherein the pre-coating comprises binder and pigment.
17. The coated paperboard product of item 16, wherein the binder of the pre-coating is selected from the group consisting of ethylene-acrylic acid copolymer (EAA), ethylene-methacrylic-acid-copolymer (EMAA), maleic acid ethylene copolymer (MAE), vinyl acetate acrylate copolymer (VAcA), styrene-acrylate copolymer (SA) and styrene-butadiene copolymer (SB).
18. The coated paperboard product of item 16 or 17, wherein the amount of pigment in the pre-coating is 10-50 wt-%, such as 15-40 wt-%, based on the dry weight of the pre-coating.
19. The coated paperboard product of item 16 or 17, wherein the amount of pigment in the pre-coating is 70-95 wt-%, such as 80-90 wt-%, based on the dry weight of the pre-coating.
20. The coated paperboard product of any one of the preceding items, wherein the amount of talc in the barrier coating is 20-40 wt-%, such as 20-35 wt-% based on the dry weight of the barrier coating.
21. The coated paperboard product of any one of the preceding items, wherein the amount of polyolefin-based binder in the barrier coating is at least 55 wt-%, such as 55-75 wt-% based on the dry weight of the barrier coating.
22. The coated paperboard product of any one of the preceding items, wherein the Cobb 1800 s value measured according to ISO 535:2014 is below 2.5 g/m².
23. The coated paperboard product of any one of the preceding items, wherein the water vapor transmission rate (WVTR) measured according to ISO 15106-1 at 38° C. and 90% relative humidity (RH) of the coated paperboard product is below 110 g/(m² day).
24. The coated paperboard product of any one of the preceding items, wherein the recyclability measured according to PTS Method PTS-RH 021/97 of the coated paperboard product is at least 80%.
25. A method of producing a coated paperboard product comprising the steps of:
   providing a paperboard substrate; and
   coating the paperboard substrate with a barrier coating, wherein the barrier coating comprises talc and a polyolefin-based binder and wherein the amount of talc in the barrier coating is 15-40 wt-% based on the dry weight of the barrier coating; and
   coating the paperboard substrate with a pre-coating prior to coating with the barrier coating so that the pre-coating is arranged between the paperboard substrate and the barrier coating in the coated paperboard product.
26. The method of item 25, wherein the barrier coating is applied in-line.
27. The method of item 25 or 26, comprising drying between the pre-coating step and the barrier-coating step.
28. The method of any one of the items 25-27, wherein the pre-coating is applied in-line.
29. The method of any one of the items 25-28, wherein the barrier coating is coated on the topside of the paperboard substrate.
30. The method of item 29, wherein the barrier coating is coated on the topside and on the reverse side of the paperboard substrate.
31. The method of item 29 or 30, wherein a PE-layer is produced as the outer layer on the reverse side of the paperboard substrate.
32. The method of item 31, wherein the PE-layer is produced by extrusion or lamination coating.
33. Use of a coating comprising talc and a polyolefin-based binder as a water-resistant barrier on a paperboard substrate, wherein the amount of talc in the barrier coating is 15-40 wt-% based on the dry weight of the barrier coating.

The inventors have realized that coating a paperboard with a barrier coating comprising 15-40 wt-% talc and a polyolefin-based binder a coated paperboard is obtained that has barrier properties combined with heat-sealability. Moreover, the need for a extrusion-coated PE-layer at least on the outside of a package produced from the coated paperboard is omitted.

### BRIEF DESCRIPTION OF THE DRAWINGS

FIG. 1 is a schematic illustration of an embodiment of the coated paperboard product 1 of the present disclosure.

FIG. 2 is a schematic illustration of an embodiment of the coated paperboard product 2 of the present disclosure.

FIG. 3 is a schematic illustration of an embodiment of the coated paperboard product 3 of the present disclosure.

FIG. 4 is a schematic illustration of an embodiment of the coated paperboard product 4 of the present disclosure.

FIG. 5 is a schematic illustration of an embodiment of the coated paperboard product 5 of the present disclosure.

FIG. 6 is a schematic illustration of an embodiment of the coated paperboard product 6 of the present disclosure.

FIG. 7 is a schematic illustration of an embodiment of the coated paperboard product 7 of the present disclosure.

FIG. 8 is a schematic illustration of an embodiment of the coated paperboard product 8 of the present disclosure.

### DETAILED DESCRIPTION

According to a first aspect of the present disclosure there is provided a coated paperboard product comprising:
a paperboard substrate; and
a barrier coating, wherein the barrier coating comprises talc and a polyolefin-based binder and wherein the amount of talc in the barrier coating is 15-40 wt-% based on the dry weight of the barrier coating; and
a pre-coating arranged between the paperboard substrate and the barrier coating.

A suitable polyolefin-based binder is typically a PE-based binder, such as the PE-based binder described in WO2021/225764 A1. The PE-based binder typically comprises a base polymer, a dispersant and a neutralizing agent. The base polymer is typically an ethylene-co-alkene copolymer comprising non-functionalized ethylene-co-alkene copolymers wherein the weight-to-weight ratio of the structural units of ethylene to alkene is typically in the range of from 99.8:0.2 to 50:50. The dispersant copolymer typically has an acid value of 130 or less and comprises structural units of ethylene and a carboxylic acid monomer. The dispersant copolymer typically has a melt flow index in the range of from 50 to 2000 g/10 min at 190° C./2.16 kg, and a weight-to-weight ratio of structural units of ethylene to carboxylic acid monomer in the range of from 95:5 to 70:30. The neutralizing agent is typically a hard base and the concentration of the neutralizing agent is sufficient to neutralize at least half of the carboxylic acid groups present in the PE-based binder.

It has surprisingly been found by the inventors that talc is a particularly suitable pigment due to its synergistic functions with the polyolefin-based binder in dry as well as humid and wet environments. The talc and polyolefin-based binder in combination displays beneficial properties with respect to water-vapour resistance, water-resistance and heat-sealability. The amount of talc in the barrier coating may be 20-40 wt-%, such as 20-35 wt-% based on the dry weight of the barrier coating. The amount of polyolefin-based binder in the barrier coating is typically at least 55 wt-%, such as 55-75 wt-% based on the dry weight of the barrier coating. Typically, additives, such as rheology modifiers, may also be added to the dispersion.

The paperboard substrate has a first side forming a topside and a second side forming a reverse side and typically the paperboard product comprises the barrier coating at least on the topside of the paperboard substrate. The paperboard product may comprise a barrier coating on the topside as well as on the reverse side of the paperboard substrate. The reverse side is the side that is intended to face the interior of a package formed from the coated paperboard and the topside is the side that faces the exterior of the package and that a consumer can see before opening. The paperboard product typically further comprises a PE-layer being the outer layer on the reverse side of the paperboard substrate. Such PE-layer protects the paperboard substrate from liquid foods.

The water resistance according to the Cobb 1800 s test (measured according to ISO 535) is typically below 2.5 g/m² on the coated paperboard product. Such Cobb 1800 value is obtained by measuring on a barrier coated paperboard without any PE-layer. Thus, by the application of the barrier coating, at least an outer PE-layer can be omitted compared with conventional paperboards for liquid foods, and thereby the PE ratio as determined by the ratio of PE of the whole coated paperboard is advantageously decreased. Typically, at least the PE-layer applied to the topside on conventional paperboards for liquid foods can be omitted.

It follows that the paperboard substrate is preferably liquid packaging board (LPB). The LPB may have a basis weight according to ISO 536:2020 of 120-300 g/m², such as 125-280 g/m². Further, the LPB typically comprises hydrophobic size, e.g. rosin size, AKD and/or ASA. In one embodiment, the LPB comprises rosin size in combination with AKD or ASA. The hydrophobic size is preferably provided as internal sizing (i.e. added in the wet end of the paperboard machine).

The weight of the barrier coating is typically at least 4 g/m², such as 4-15 g/m², such as 5-10 g/m², such as 4-9 g/m². From an economical and environmental perspective, it is advantageous to keep the coat weight as low as possible and in a full-scale coating machine, the coat weight can be kept lower than in a laboratory equipment.

The coated paperboard product comprises a pre-coating arranged between the paperboard substrate and the barrier coating. If the surface of the paperboard substrate is rough, it is beneficial to apply a pre-coating to level out the surface. The pre-coating typically comprises binder and pigment. The amount of pigment in the pre-coating is typically 10-50 wt-%, such as 15-40 wt-%, based on the dry weight of the pre-coating. Such an amount of pigment is beneficial for water vapour barrier properties. Alternatively, the amount of pigment in the pre-coating is 70-95 wt-%, such as 80-90 wt-%, based on the dry weight of the pre-coating. The barrier coating is typically almost optically transparent and a higher amount of pigment in the pre-coating is beneficial when a higher brightness of the coated paperboard product is desired.

The binder in the pre-coating is typically selected from the group consisting of ethylene-acrylic acid copolymer (EAA), ethylene-methacrylic-acid-copolymer (EMAA), maleic acid ethylene copolymer (MAE), vinyl acetate acrylate copolymer (VAcA), styrene-acrylate copolymer (SA) and styrene-butadiene copolymer (SB). The invention is not limited to a specific type of binder in the pre-coating and other binders of similar properties are also suitable.

The paperboard substrate may be surface sized, typically with a starch-based surface sizing to prevent, or at least decrease, the risk of curl and dust. Typically if the barrier coating is arranged on the topside of the paperboard substrate, the reverse side is beneficial to surface size with starch. On the other hand, if there is a barrier coating arranged on both topside and reverse side, the paperboard substrate is typically not surface sized on any of the sides.

The paperboard substrate typically comprises a first layer and a second layer, and the first and second layer of the paperboard substrate typically comprises chemical pulp, such as kraft pulp, preferably each of the first and second layer of the paperboard substrate comprises at least 80 wt-% kraft pulp based on the dry weight of the first and second layers. Such amount of kraft pulp is beneficial as it provides high strength. The density measured according to ISO 534:2011 of the first and second layers of the paperboard substrate is typically above 650 kg/m³, such as above 700 kg/m³, such as above 750 kg/m³.

The paperboard substrate typically further comprises a third layer arranged between the first layer and the second layer, wherein the third layer comprises mechanical pulp, such as chemitermomechanical pulp (CTMP). The density measured according to ISO 534:2011 of the third layer of the paperboard substrate is typically below 600 kg/m³, such as below 550 kg/m³. By arranging a third layer comprising mechanical pulp between the first and second layer an I-beam structure is formed combining strength, rigidity and low density.

In case the baseboard is a multi-layered baseboard having more than one layer in the baseboard, the individual layers can be separated as individual layers from the multi-layered paperboard. Thereby measurement of the individual layers is facilitated. For such separation, a FORTUNA Bandknife-Splitting Machine (Type AB 320 E/P) can be used. Such a machine that has been customized for paperboard splitting is commercially available and is used by several major companies in the paperboard field.

Alternatively, a surface grinding technique can be used to remove all layers but the layer of interest. Such a surface grinding is one of the services that are commercially available at RISE Bioeconomy (formerly Innventia) in Stockholm, Sweden.

All layers are produced from individual furnishes and such furnishes typically further comprises broke pulp.

The water vapor transmission rate (WVTR) measured according to ISO 15106-1 at 38° C. and 90% relative humidity (RH) of the coated paperboard product is typically below 110 g/(m² day).

The recyclability measured according to PTS Method PTS-RH 021/97 of the coated paperboard product is typically at least 80%.

According to a second aspect of the present disclosure there is provided a method of producing a coated paperboard product comprising the steps of:
providing a paperboard substrate; and
coating the paperboard substrate with a barrier coating, wherein the barrier coating comprises talc and a polyolefin-based binder and wherein the amount of talc in the barrier coating is 15-40 wt-% based on the dry weight of the barrier coating; and
coating the paperboard substrate with a pre-coating prior to coating with the barrier coating so that the pre-coating is arranged between the paperboard substrate and the barrier coating in the coated paperboard product.

The barrier coating is typically coated on the topside of the paperboard substrate. In embodiments, the barrier coating is coated on the topside and on the reverse side of the paperboard substrate.

The pre-coating may be applied in-line (also referred to as on-line). The barrier coating may also be applied in-line. In such case, the productivity is increased by eliminating the handling operations linked to off-line treatment and by eliminating, or at least reducing, the amount of waste. In one embodiment, the method comprises drying between the application of the pre-coating layer and the application of the barrier coating layer. Drying is typically performed with non-contact drying, such as IR and/or hot air, or contact drying, such as a drying cylinder, or a combination of non-contact and contact drying.

The coating may be conducted with blade coating, rod coating, air-knife coating, rotogravure coating and/or curtain coating. The pre-coating and barrier coating layers may be applied with the same coating technique or different coating techniques.

Typically, a PE-layer is produced as the outer layer on the reverse side of the paperboard substrate. In such case, the PE-layer is typically produced by extrusion or lamination coating.

The examples and embodiments discussed above in connection to the first aspect apply to the second aspect mutatis mutandis.

According to a third aspect of the present disclosure there is provided use of a coating comprising talc and a polyolefin-based binder as a water-resistant barrier on a paperboard substrate, wherein the amount of talc in the barrier coating is 15-40 wt-% based on the dry weight of the barrier coating.

The examples and embodiments discussed above in connection to the first and second aspect apply to the third aspect mutatis mutandis.

The aspects of the present disclosure will now be described with reference to the accompanying drawings, in which certain embodiments of the invention are shown. Like numbers refer to like elements throughout the description.

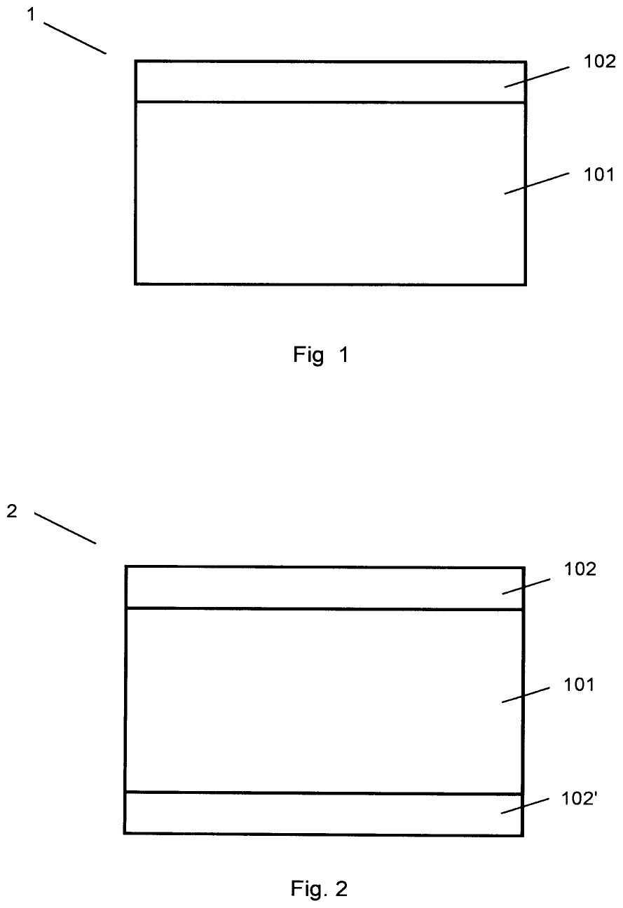

FIG. 1 is a schematic illustration of an embodiment of the coated paperboard product 1 of the present disclosure. The paperboard product comprises a paperboard substrate 101 and a barrier coating layer 102 on the topside of the paperboard substrate. Between the barrier coating 102 and the paperboard substrate 101 there is a pre-coating layer 103.

FIG. 2 is a schematic illustration of an embodiment of the coated paperboard product 2 of the present disclosure. The paperboard product comprises a paperboard substrate 101 and barrier coating layers 102, 102′, wherein barrier coating 102 is on the topside and barrier coating 102′ is on the reverse side of the paperboard substrate. Between the paperboard substrate 101 and the barrier coating layers 102, 102′ there are pre-coating layers 103,103′.

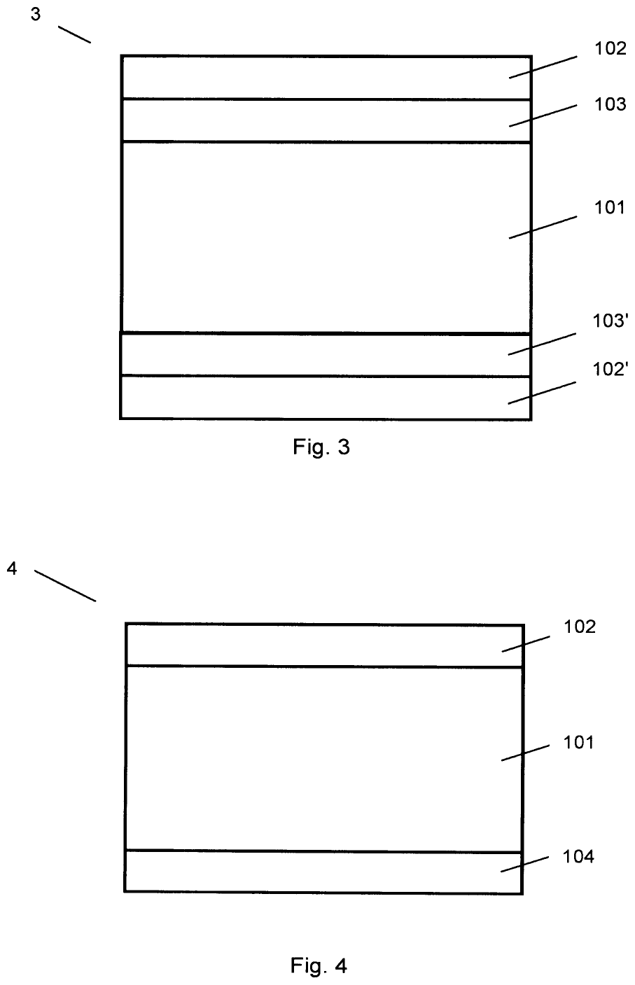

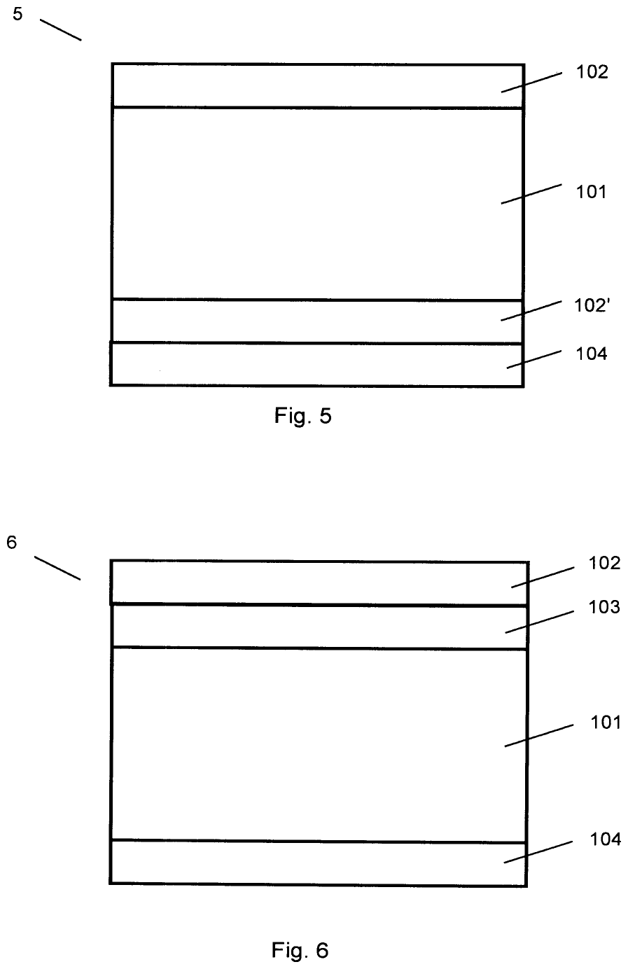

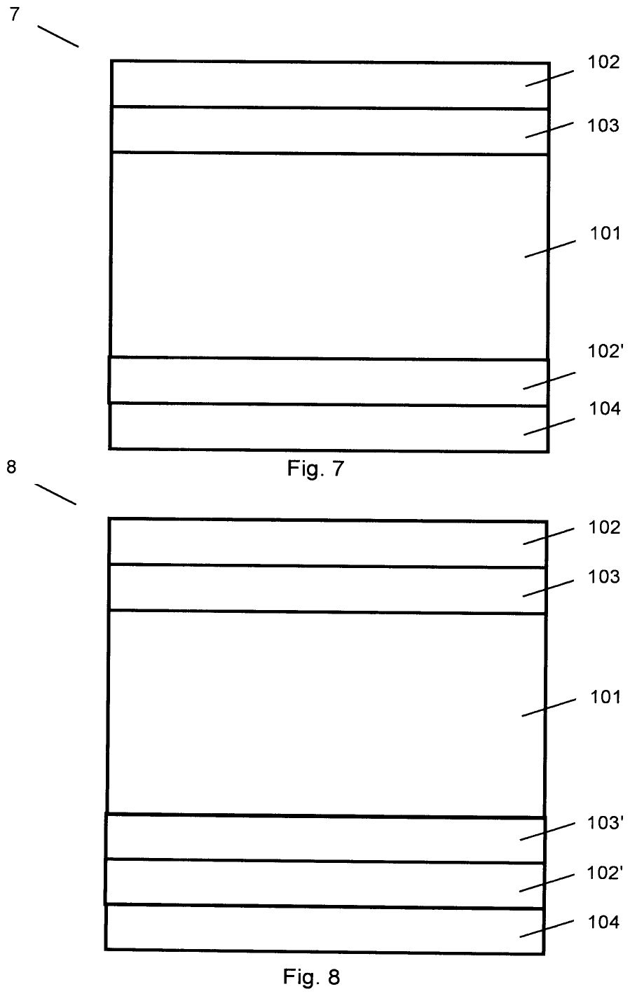

FIG. 3 is a schematic illustration of an embodiment of the coated paperboard product 3 of the present disclosure. The paperboard product comprises a paperboard substrate 101 and barrier coating layer 102, wherein barrier coating 102 is on the topside of the paperboard substrate. Between the barrier coating 102 and the paperboard substrate 101 there is a pre-coating layer 103. On the reverse side of the paperboard substrate 101 there is a PE-layer 104.

FIG. 4 is a schematic illustration of an embodiment of the coated paperboard product 4 of the present disclosure. The paperboard product comprises a paperboard substrate 101 and barrier coating layers 102, 102′, wherein barrier coating 102 is on the topside and barrier coating 102′ is on the reverse side of the paperboard substrate 101. Between the barrier coating layer 102 and the paperboard substrate 101 there is a pre-coating layer 103 and between the barrier coating layer 102′ and the paperboard substrate 101 there is a pre-coating layer 103′. On the barrier coating 102 there is a PE-layer 104, and on the barrier coating layer 102′ there is a PE-layer 104′.

### EXAMPLES

### Barrier Coating of Paperboard

Various amounts of pigment (talc (Finntalc C15B2), kaolin clay (Barrisurf LX) or CaCO₃ (Setacarb HG-ME 75%)) were dispersed in a polyolefin-based binder (the binder is further described in WO2021/225764 A1 by Dow Global Technologies) having a solids content of about 50%.

A baseboard (268 g/m²) having 3 plies: a top-ply of bleached kraft pulp, a centre ply with of a mix of CTMP, kraft fibres and broke pulp, and a bottom inner ply of unbleached kraft pulp was used as paperboard substrate. The baseboard was coated with a pre-coating containing 95 parts CaCO3 (HydroCarb 75), 5 parts kaolin clay (Kaovit), 16 parts styrene-acrylate (SA) latex (SA 95085.05), and 0.23 parts rheology modifier (CartaCoat RM15) using a pilot-scale blade coater at a coat weight of each pre-coating of about 13 g/m².

On top of the pre-coated baseboards, the different barrier coatings were coated with a pilot-scale blade coater at a coat weight of each barrier coating of about 8 g/m².

For evaluation of heat-sealing, the different barrier coatings were coated with a pilot-scale blade coater at a coat weight of each barrier coating of about 8 g/m²on paper sheets (about 70-80 g/m²) to fit into the equipment for testing of heat-sealability.

The properties of the barrier coated baseboard is shown in Table 2 below.

### Curtain Coating

In addition to blade coating, it has been evaluated to coat with curtain coating.

Two barrier coatings were prepared from 15 wt % and 30 wt % talc (Finntalc C15B3) that was dispersed together with rheology modifiers and surfactant in a polyolefin-based binder (the binder is further described in WO2021/225764 A1 by Dow Global Technologies) having a solids content of about 50%. The viscosity was about 200 mPas and the minimum flow was set to 6.2 L/min (for 30 wt % talc) and 4.6 L/min (for 15 wt % talc).

The barrier coatings were successfully coated onto pre-coated baseboard.

### Test Parameters

For the blade coated baseboards, the following parameters were evaluated, and the standard used for each evaluation is listed below:
Cobb1800 (ISO535)
WVTR @38° C./90% RH (ASTM F1249)
PTS Recyclability (PTS-RH 021/97)
Friction (ISO-8295)
Runnability
Heat-sealing/Seal Strength @160° C./0.5 s/3 bar (ASTM F88, EN 868-5*) on barrier coated paper sheets

To be suitable as a coated paperboard substrate for packages of liquid food the criteria presented in Table 1 should preferably be met.

TABLE 1
Desired properties to be suitable as
substrate for package of liquid food.

| Desired property | Analysis | Range | |
|---|---|---|---|
| Water barrier | Cobb1800 | <2.5 | g/m² |
| Water vapour barrier | WVTR @ 38° C./ | <110 | g/m2/day |
| | 90 % RH | | |

| | | |
|---|---|---|
| Runnability | — | Addition of |
| | | pigments >10% |
| Heat-seal with fibre tear | Seal Strength | Fibre tear @ >4N |
| PTS Recyclability | PTS PTS-RH 021/97 | >80% |
| Appropriate range of | Test of friction | 0.5-0.7 |
| friction | | |

Moreover, heat-sealing of barrier coated paper sheets yielding a heat-seal with fibre tear as well as a seal strength of >4N is equivalent to the seal strength needed by the converters to form a liquid-tight seal in a package from a paperboard coated with the same type of barrier.

TABLE 2
Properties of the barrier-coated baseboards.

| | Pigment in | | | | | | Heat |
|---|---|---|---|---|---|---|---|
| | barrier | | | | PTS | Friction | seal |
| | coating | Cobb1800 | | | Recyclability | (COF | Fmax |
| Sample | (wt-%) | (g/m²) | WVTR | Runnability | (%) | Static) | (N)* |
| 1 | 0% pigment | 0.7 | 89 | Fail** | 91 | 0.56 | 4.6 |
| 2 | 10% talc | 1.1 | 104 | Fail** | 92 | 0.63 | 4.8 |
| 3 | 25% talc | 0.7 | 100 | Pass | 92 | 0.58 | 4.7 |
| 4 | 30% talc | — | 103 | Pass | — | 0.63 | — |
| 5 | 50% talc | 4.0 | 99 | Pass | 96 | — | 3.4 |
| 6 | 75% talc | 94.6 | 95 | Pass | 97 | — | 0.5 |
| 7 | 10% CaCO3 | 1.2 | 101 | Fail** | 92 | — | 4.7 |
| 8 | 25% CaCO3 | — | — | Fail*** | — | — | — |
| 9 | 50% CaCO3 | — | — | Fail*** | — | — | — |
| 10 | 75% CaCO3 | — | — | Fail*** | — | — | — |
| 11 | 10% clay | 1.9 | 87 | Fail** | 90 | 0.54 | 4.5 |
| 12 | 25% clay | 14.2 | 102 | Pass | 91 | — | 4.3 |
| 13 | 50% clay | 68.2 | 101 | Pass | 96 | — | 1.9 |
| 14 | 75% clay | 94.8 | 89 | Pass | 98 | — | No seal |
| 15 | 25% talc**** | 8.3 | Failed | — | — | — | — |

*Heat-sealability tested on barrier-coated paper sheets instead of paperboard to fit into the testing equipment.
**Fail because dispersion could not be pumped and the rheology profile was unsatisfactory for application as a coating.
***Additions of CaCO3 resulted in that the coating had a high increase in viscosity and an even coating could not be obtained as a result from that the CaCO3 reacted with the binder.
****The barrier coating was coated directly on the paperboard without any pre-coating.

As indicated in Table 2, no or only 10% pigment is insufficient for runnability.

25% and 30% talc did not fail any of the criteria in Table 2. A further increase of the proportion of talc to 50%, however, affected both Cobb1800 and heat sealing negatively.

Regarding clay as a pigment, the addition of more than 10% negatively affected the water resistance (Cobb1800).

Without application of a pre-coat the barrier properties are unsatisfactory. The WVTR at 38° C./90% RH failed because it was too high to even be able to measure.

1. A coated paperboard product comprising:
a paperboard substrate; and
a barrier coating, wherein the barrier coating comprises talc and a polyolefin-based binder and wherein the amount of talc in the barrier coating is 15-40 wt-% based on the dry weight of the barrier coating; and
a pre-coating arranged between the paperboard substrate and the barrier coating.

2. The coated paperboard product of claim 1, wherein the grammage measured according to ISO 536:2020 of the paperboard substrate is 120-300 g/m², such as 125-280 g/m².

3. The coated paperboard product of claim 1 or 2, wherein the coat weight of the barrier coating is at least 4 g/m², such as 4-15 g/m², such as 5-10 g/m².

4. The coated paperboard product of any of the preceding claims, wherein the polyolefin-based binder is a polyethylene (PE)-based binder.

5. The coated paperboard product of any of the preceding claims, wherein the paperboard substrate has a first side forming a top side and a second side forming a reverse side and wherein the paperboard product comprises said barrier coating on the top side of the paperboard substrate.

6. The coated paperboard product of any one of claim 5, wherein the paperboard product comprises said barrier coating on the topside and on the reverse side of the paperboard substrate.

7. The coated paperboard product of any one of claim 5 or 6, further comprising a PE-layer being the outer layer on the reverse side of the paperboard substrate.

8. The coated paperboard product of any one of the preceding claims, wherein the pre-coating comprises binder and pigment.

9. The coated paperboard product of claim 8, wherein the binder of the pre-coating is selected from the group consisting of ethylene-acrylic acid copolymer (EAA), ethylene-methacrylic-acid-copolymer (EMAA), maleic acid ethylene copolymer (MAE), vinyl acetate acrylate copolymer (VAcA), styrene-acrylate copolymer (SA) and styrene-butadiene copolymer (SB).

10. A method of producing a coated paperboard product comprising the steps of:
providing a paperboard substrate; and
coating the paperboard substrate with a barrier coating, wherein the barrier coating comprises talc and a polyolefin-based binder and wherein the amount of talc in the barrier coating is 15-40 wt-% based on the dry weight of the barrier coating; and
coating the paperboard substrate with a pre-coating prior to coating with the barrier coating so that the pre-coating is arranged between the paperboard substrate and the barrier coating in the coated paperboard product.

11. The method of any one claim 10, wherein the barrier coating is coated on the topside of the paperboard substrate.

12. The method of claim 11, wherein the barrier coating is coated on the topside and on the reverse side of the paperboard substrate.

13. Use of a coating comprising talc and a polyolefin-based binder as a water-resistant barrier on a paperboard substrate, wherein the amount of talc in the barrier coating is 15-40 wt-% based on the dry weight of the barrier coating.
